(19) United States
(12) Patent Application Publication
(10) Pub. No.: US 2009/0166910 A1
(43) Pub. Date: Jul. 2, 2009

(54) System and Method for Twin Screw Extrusion of a Fibrous Porous Substrate

(75) Inventors: James M. Marshall, Johnstown, PA (US); James Jenq Liu, Mason, OH (US)

Correspondence Address: GEO2 TECHNOLOGIES, 12-R CABOT ROAD, WOBURN, MA, 01801, US

(73) Assignee: GEO2 TECHNOLOGIES, INC., Woburn, MA (US)

(21) Appl. No.: 12/349,138

(22) Filed: Jan. 6, 2009

Related U.S. Application Data
(63) Continuation-in-part of application No. 11/322,777, filed on Dec. 30, 2005.
(60) Provisional application No. 60/737,237, filed on Nov. 16, 2005.

(51) Int. Cl. B29C 67/20; B29C 47/38

(52) U.S. Cl. 264/46.1; 425/113

(57) ABSTRACT

This invention provides a system and method for forming a fibrous porous ceramic substrate that employs a screw extruder, and illustratively, a twin screw extruder to form a substrate by directing a homogeneous, wetted and mixed group of substrate components through a screw extruder die under pressure. The components of the mixture can be initially mixed in a substantially dry state by an appropriate mixer to form a homogeneous powder with a high dispersal of materials therein. The powder can be continuously mixed and conveyed to a feeder of the extruder. Along the path of the extruder, fluid can be introduced at a metered rate, along with other additives, such as colloidal silica (glass binder). The extruder's twin, co-rotating shafts include a combination of screw elements for feeding the mixture and shear-inducing mixing elements (kneading blocks) for thoroughly mixing fluid into the dry components. The wetted components pass through alternating sets of transport screws and kneading blocks until the kneaded, wetted mixture finally enter a vacuum section of the extruder where a vacuum is applied to remove excess air pockets and/or bubbles from the mixture. The mixture is thereafter driven through the die head where it exits as a continuous, extruded shape. Such a shape can comprise a honeycomb useful in filtration applications. The extruder can include a cooling system. The fifer in the mixture can be mullite. Alternatively the mixture can form a silicon carbide or other type of porous substrate matrix.

### CROSS-REFERENCE TO RELATED APPLICATIONS

This application is a continuation-in-part of U.S. patent application Ser. No. 11/323,429 filed Dec. 30, 2005, which claims the benefit of provisional patent application 60/737,237 filed Nov. 16, 2005, both of which are herein incorporated by reference.

### FIELD OF THE INVENTION

The present invention relates generally to extrusion processes for forming a fibrous porous substrate.

### BACKGROUND OF THE INVENTION

Fiber-based ceramic substrates are commonly used for high-temperature processes, such as exhaust filtration, insulation, and as a catalytic host in chemical reactors. Fiber-based ceramic substrates provide high operating temperature capabilities, with high strength and chemical inertness. For example, ceramic fiber-based substrate materials are useful for high temperature insulation, filtration, and for hosting catalytic reactions. The materials, in any of a variety of forms, can be used in high-temperature applications, such as catalytic converters, NOx adsorbers, DeNox filters, multi-function filters, molten metal transport mechanisms and filters, regenerator cores, chemical processes, fixed-bed reactors, hydrodesulfurization, hydrocracking or hydrotreating, and engine exhaust filtration.

The high porosity, and high effective surface area provided by the fibrous microstructure provide excellent strength at low mass, and can survive wide and sudden temperature excursions without exhibiting thermal shock or mechanical degradation. Ceramic fibers can also be used to fabricate high temperature rigid insulating panels, such as vacuum cast boards, used for lining combustion chambers and high temperature environments that require impact resistance. Casting processes can also be used to form rigid structures composed of ceramic fibers such as kiln furniture and setter tiles.

It is desirable to provide a system and method for forming high porosity substrates from fibrous materials using commercially available extrusion processes that are known for producing powder-based or particle-based materials, while maintaining the advantaged microstructure and properties of fiber-based materials.

### BRIEF SUMMARY OF THE INVENTION

This invention overcomes the disadvantages of the prior art by providing a system and method for forming a fibrous porous ceramic substrate that employs a screw extruder, and illustratively, a twin screw extruder to form a substrate by directing a homogeneous, wetted and mixed group of substrate components (raw materials) through a screw extruder die under pressure. The components of the mixture can be initially mixed in a substantially dry state by an appropriate mixer to form a homogeneous mixture with a high dispersal of materials therein. In the method of the present invention, the homogeneous mixture comprises at least 20% by volume fibrous materials. The mixture can be continuously mixed and conveyed to a feeder of the extruder—a screw feeder that regulates the feed rate—whereby the substrate can be extruded in a substantially continuous process, with new material provided to the feed port of the extruder as green substrate exists the die. Along the path of the extruder, fluid can be introduced at a metered rate, along with other additives, such as colloidal silica (glass binder). The extruder's twin, co-rotating, or optionally, counter-rotating, shafts include a combination of screw elements for feeding the mixture and shear-inducing mixing elements (kneading blocks) for thoroughly mixing fluid into the dry components. The wetted components pass through alternating sets of transport screws and kneading blocks until the kneaded, wetted mixture finally enter a vacuum section of the extruder where a vacuum is applied (typically stuffer vent) to remove excess air pockets and/or bubbles from the mixture. The mixture is thereafter driven through the die head where it exits as a continuous, extruded shape. Such a shape can comprise a honeycomb useful in filtration applications. The extruder can include a cooling system interconnected with a chiller or other heat-transport mechanism. The die head can include appropriate transition pieces between the end of the screws and the face of the die so as to ensure a well-formed green extruded substrate. This transition piece can compensate for the figure-eight-to-circle (8-0) shape transition between the extruder barrel and the die.

In an illustrative embodiment, the mixer can comprise a horizontal plow mixer capable of either batch feed or continuous feed. The fluid can be applied to one or more adjacent sections/segments of the extruder casing, and can include other additives, such as colloidal silica (a high-temperature bonding agent). Other materials, including, in an illustrative embodiment, mullite fiber, graphite pore former, HPMC binder and bentonite strengthener can be part of the mixture that is continuously fed to the extruder via the screw feeder and feed port. In alternate embodiments, the materials can be selected to generate a glass-bonded or reaction-bonded silicon carbide-based substrate in a cured form. Other types of raw materials can be used to form the substrate's porous matrix in alternate embodiments.

### BRIEF DESCRIPTION OF THE SEVERAL VIEWS OF THE DRAWING

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram of a system for extruding a porous substrate in accordance with the present invention;

FIG. 2 is an illustration of a fibrous extrudable mixture in accordance with the present invention;

FIGS. 3A and 3B are illustrations of an open cell network in accordance with the present invention;

FIG. 4 is an electron microscope picture of an open cell network in accordance with the present invention and a closed cell network of the prior art;

FIG. 5 is an illustration of a filter block using a porous substrate in accordance with the present invention;

FIG. 6 is a compilation of tables showing fibers, binders, pore formers, fluids, and rheologies useful with the present invention;

FIG. 7 is a schematic side view of a twin screw extruder arranged to extrude a fibrous porous ceramic substrate in accordance with an illustrative embodiment of this invention;

FIG. 8 is a cross section of the casing of the twin screw extruder taken along line 8-8 of FIG. 7;

FIG. 9 is a schematic side view of one of a pair of extrusion screw shafts, and associated screw shaft sections shown with respect to extruder casing sections, the shaft being arranged to extrude the fibrous porous ceramic substrate in accordance with the illustrative embodiment of FIG. 7;

FIG. 10 is a front view of an exemplary horizontal plow mixer for producing a dry pre-mixed blend of substrate components according to an illustrative embodiment;

FIG. 11 is an electron microscope picture of the pre-blended dry homogeneous mixture of substrate components prepared employing a horizontal plow mixer such as that shown in FIG. 10;

FIG. 12 is an electron microscope picture showing a close-up view of a portion of the electron microscope picture of FIG. 11;

FIG. 13 is a flow diagram detailing the procedure for forming a green, unfired substrate from unmixed components using a twin screw extruder according to an illustrative embodiment of this invention;

FIG. 14 is an electron microscope picture of the internal structure of a cured fibrous porous ceramic substrate formed using the illustrative twin screw extruder of FIG. 7;

FIG. 15 is an electron microscope picture showing a close-up view of a portion of the electron microscope picture of FIG. 14;

FIG. 16 is a block diagram of a system for extruding a porous substrate in accordance with the present invention; and

FIG. 17 is a block diagram of a system for curing a porous substrate in accordance with the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

Highly porous and rigid structures can be formed from fibrous materials that maintain structural integrity at extremely high temperatures in order to meet the processing requirements of the intended application. The ceramic fiber forming the basis for the substrate material composition can be fabricated from a number of materials in a variety of processes. For example, ceramic materials can be drawn into a fiber from a sol-gel, or melt-spun into fibers.

One exemplary material from which substrates can be formed is polycrystalline mullite (alumina silica 3Al₂O₃.2SiO₂ or 2Al₂O₃.SiO₂) fiber, which is highly stable and exhibits mechanical integrity at temperatures in excess of 1700° C. Moreover, mullite exhibits relatively low fibro-toxicity when ingested or inhaled. Another exemplary substrate material is a silicon carbide SiC-based material. That can be either glass-bonded (i.e. glass-bonded silicon carbide) or reaction bonded (i.e. reaction-bonded silicon carbide).

As discussed in further detail below, the formation of substrates from raw fiber material is a multi-step process entailing particular mixtures of powdered/fibrous components with a fluid (typically water). These initial mixture components include a fiber of appropriate size and diameter, an organic binder that maintains the shape of the substrate during and after extrusion, an inorganic bonding phase (such as a silicate/glass material and clay/bentonite) that coats and sinters the fibers together into the final substrate lattice during high-temperature firing) and a pore former (such as fine graphite) that fills the space between fibers and vaporizes at high temperature to leave the empty substrate pores. The initial components and fluid are combined into a semi-viscous medium, and then illustratively extruded into the desired substrate shape. This extruded shape, consisting of a “green” or unfired ceramic, is then dried to remove moisture, and finally fired to various degrees to form the final substrate. The complete fabrication process is described in further detail below and can be found with reference to U.S. patent application Ser. No. 11/831,398, entitled A FIBER-BASED CERAMIC SUBSTRATE AND METHOD OF FABRICATING THE SAME, the teachings of which are expressly incorporated herein by reference.

Co-pending, commonly assigned U.S. patent application Ser. No. 11/323,429, filed Dec. 30, 2005, which claims the benefit of U.S. Provisional Patent Application 60/737,237, filed Nov. 16, 2005, both of which are herein incorporated by reference, described a system and method for extruding a green substrate having the desired shape using generally a piston extruder. In this embodiment, described further below, the extruder receives a predetermined volume of a mixture of components needed to eventually for the desired fired substrate, and forces the mixture through an extrusion die to thereby form a predetermined length of extruded substrate. The predetermined volume of mixture is placed into a form acceptable for extrusion prior to admission to the piston extruder. That is, the mixture is mixed together and an appropriate quantity of fluid (typically water) is added to create an extrudable compound. This compound is then admitted as a batch to the extruder. When the compound is exhausted, the extruder piston is retracted and a new batch can be admitted to the feed section of the extruder. While the piston extruder provides a precise and repeatable end product, this approach, thus limits the volume of substrate that can be produced in a single extruder cycle. Thus, mass-production of substrates using the piston-extrusion process is slowed by the need to blend new batches of the mixture, and then apply them to the extruder's feed bin. While the process can be accelerated by employing multiple extruders in parallel to process a larger overall batch, this approach adds significantly to equipment costs, as well as the costs of servicing and maintaining them.

It is desirable to provide a system and method for forming fibrous porous substrates using a commercially available continuous-feed extrusion process, such as that available via a screw extruder, where a hopper receives a continuing, metered supply of mixture. However, screw extruders are typically more sensitive to the viscosity and variability of the mixture. Thus known approaches involving the premixing of a wetted dough and applying this dough to the extruder are not generally effective. If the mixture is not with proper consistency ranges, then clumping, chunking and/or clogging of the extruder's feed screws and associated components can occur. Therefore, the addition of components and fluid to a screw extruder must be carefully controlled, making the problem non-trivial. Moreover, little guidance exists in industry for the extrusion of fibrous porous ceramic materials. A careful combination of drive screw elements, agitators and other extruder components is needed to present the proper consistency of mixture to the downstream extrusion die. Likewise, an extrusion technique that provides a more-homogeneous mixture may also be desirable.

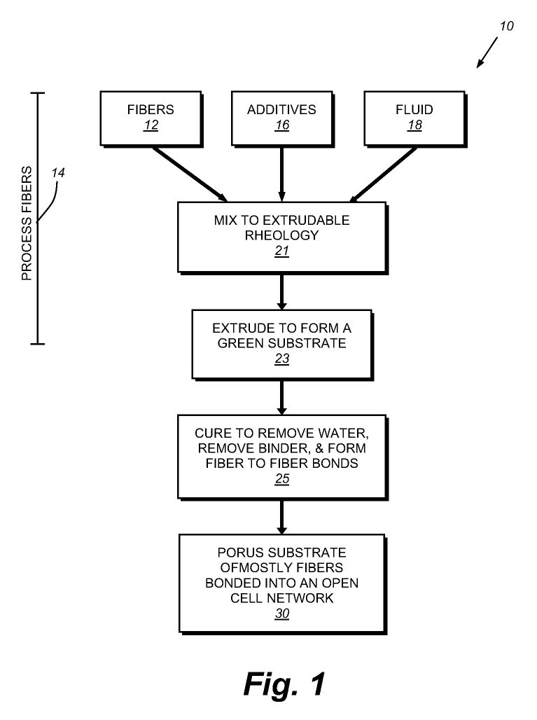

Referring now to FIG. 1, a system for extruding a porous substrate is illustrated. Generally, system 10 uses an extrusion process to extrude a green substrate that can be cured into the final highly porous substrate product. System 10 advantageously produces a substrate having high porosity, having a substantially open pore network enabling an associated high permeability, as well as having sufficient strength according to application needs. The system 10 also produces a substrate with sufficient cost effectiveness to enable widespread use of the resulting filters and catalytic converters. The system 10 is easily scalable to mass production, and allows for flexible chemistries and constructions to support multitudes of applications.

System 10 enables a highly flexible extrusion process, so is able to accommodate a wide range of specific applications. In using system 10, the substrate designer first establishes the requirements for the substrate. These requirements may include, for example, size, fluid permeability, desired porosity, pore size, mechanical strength and shock characteristics, thermal stability, and chemical reactivity limitations. According to these and other requirements, the designer selects materials to use in forming an extrudable mixture. Importantly, system 10 enables the use of fibers 12 in the formation of an extruded substrate. These fibers may be, for example, ceramic fibers, organic fibers, inorganic fibers, polymeric fibers, oxide fibers, vitreous fibers, glass fibers, amorphous fibers, crystalline fibers, non-oxide fibers, carbide fibers, metal fibers, other inorganic fiber structures, or a combination of these. However, for ease of explanation, the use of ceramic fibers will be described, although it will be appreciated that other fibers may be used. Also, the substrate will often be described as a filtering substrate or a catalytic substrate, although other uses are contemplated and within the scope of this teaching. The designer selects the particular type of fiber based upon application specific needs. For example, the ceramic fiber may be selected as a mullite fiber, an aluminum silicate fiber, or other commonly available ceramic fiber material. The fibers typically need to be processed 14 to cut the fibers to a usable length, which may include a chopping process prior to mixing the fibers with additives. Also, the various mixing and forming steps in the extrusion process will further cut the fibers.

According to specific requirements, additives 16 are added. These additives 16 may include binders, dispersants, pore formers, plasticizers, processing aids, and strengthening materials. Also, fluid 18, which is typically water, is combined with the additives 16 and the fibers 12. The fibers, additives, and fluid are mixed to an extrudable rheology 21. This mixing may include dry mixing, wet mixing, and shear mixing. The fibers, additives, and fluid are mixed until a homogeneous mass is produced, which evenly distributes and arranges fibers within the mass. The fibrous and homogenous mass is then extruded to form a green substrate 23. The green substrate has sufficient strength to hold together through the remaining processes.

The green substrate is then cured 25. As used in this description, “curing” is defined to include two important process steps: 1) binder removal and 2) bond formation. The binder removal process removes free water, removes most of the additives, and enables fiber to fiber contact. Often the binder is removed using a heating process that burns off the binder, but it will be understood that other removal processes may be used dependent on the specific binder used. For example, some binder may be removed using an evaporation or sublimation process. Some binders and or other organic components may melt before degrading into a vapor phase. As the curing process continues, fiber to fiber bonds are formed. These bonds facilitate overall structural rigidity, as well as create the desirable porosity and permeability for the substrate. Accordingly, the cured substrate 30 is a highly porous substrate of mostly fibers bonded into an open pore network 30. The substrate may then be used as a substrate for many applications, including as a substrate for filtering applications and catalytic conversion applications. Advantageously, system 10 has enabled a desirable extrusion process to produce substrates having porosities of up to about 90%.

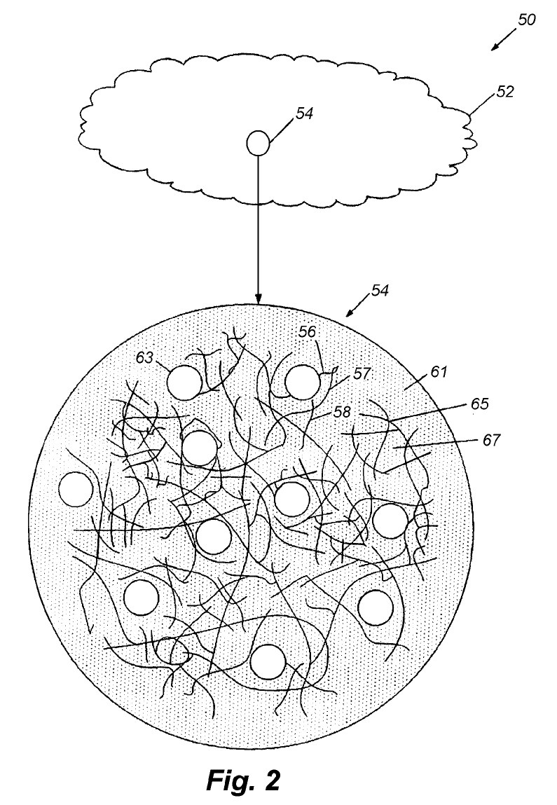

Referring now to FIG. 2, an extrudable material 50 is illustrated. The extrudable material 50 is ready for extrusion from an extruder, such as a piston or screw extruder. The extrudable mixture 52 is a homogeneous mass including fibers, plasticizers, and other additives as required by the specific application. FIG. 2 illustrates an enlarged portion 54 of the homogeneous mass. It will be appreciated that the enlarged portion 54 may not be drawn to scale, but is provided as an aid to this description. The extrudable mixture 52 contains fibers, such as fibers 56, 57, and 58. These fibers have been selected to produce a highly porous and rigid final substrate with desired thermal, chemical, mechanical, and filtration characteristics. As will be appreciated, substantially fibrous bodies have not been considered to be extrudable, since they have no plasticity of their own. However, it has been found that through proper selection of plasticizers and process control, an extrudable mixture 52 comprising fibers may be extruded. In this way, the cost, scale, and flexibility advantages of extrusion may be extended to include the benefits available from using fibrous material.

Generally, a fiber is considered to be a material in a fiber form. Many materials of various compositions can be provided in fibrous form, through known fiberization processes that can include drawing, spinning, or blowing a solution or melted form of the material. A fiber is typically a material with a relatively small diameter having an aspect ratio greater than one. The aspect ratio is the ratio of the length of the fiber divided by the diameter of the fiber. As used herein, the ‘diameter’ of the fiber assumes for simplicity that the sectional shape of the fiber is a circle; this simplifying assumption is applied to fibers regardless of their true sectional shape. For example, a fiber with an aspect ratio of 10 has a length that is 10 times the diameter of the fiber. The diameter of the fiber may be 6 micron, although diameters in the range of about 1 micron to about 25 microns are readily available. It will be understood that fibers of many different diameters and aspect ratios may be successfully used in system 10. As will be described in more detail with reference to later figures, several alternatives exist for selecting aspect ratios for the fibers. It will also be appreciated that the shape of fibers is in sharp contrast to the typical ceramic powder, where the aspect ratio of each ceramic particle is approximately 1.

The fibers for the extrudable mixture 52 may be metallic (some times also referred to as thin-diameter metallic wires), although FIG. 2 will be discussed with reference to ceramic fibers. The ceramic fibers may be in an amorphous state, a vitreous state, a crystalline state, a poly-crystalline state, a mono-crystalline state, or in a glass-ceramic state. In making the extrudable mixture 52, a relatively low volume of ceramic fiber is used to create the porous substrate. For example, the extrudable mixture 52 may have only about 10% to 40% ceramic fiber material by volume. In this way, after curing, the resulting porous substrate will have a porosity of about 90% to about 60%. It will be appreciated that other amounts of ceramic fiber material may be selected to produce other porosity values.

In order to produce an extrudable mixture, the fibers are typically combined with a plasticizer. In this way, the fibers are combined with other selected organic or inorganic additives. These additives provide three key properties for the extrudate. First, the additives allow the extrudable mixture to have a rheology proper for extruding. Second, the additives provide the extruded substrate, which is typically called a green substrate, sufficient strength to hold its form and position the fibers until these additives are removed during the curing process. And third, the additives are selected so that they burn off in the curing process in a way that facilitates arranging the fibers into an overlapping construction, and in a way that does not weaken the forming rigid structure. Typically, the additives will include a binder, such as binder 61. The binder 61 acts as a medium to hold the fibers into position and provide strength to the green substrate. The fibers and binder(s) may be used to produce a porous substrate having a relatively high porosity. However, to increase porosity even further, additional pore formers, such as pore former 63, may be added. Pore formers are added to increase open space in the final cured substrate. Pore formers may be spherical, elongated, fibrous, or irregular in shape. Pore formers are selected not only for their ability to create open space and based upon their thermal degradation behavior, but also for assisting in orienting the fibers. In this way, the pore formers assist in arranging fibers into an overlapping pattern to facilitate proper bonding between fibers during later stage of the curing. Additionally, pore-formers also play a role in the alignment of the fibers in preferred directions, which affects the thermal expansion of the extruded material and the strength along different axes.

As briefly described above, extrudable mixture 52 may use one or more fibers selected from many types of available fibers. Further, the selected fiber may be combined with one or more binders selected from a wide variety of binders. Also, one or more pore formers may be added selected from a wide variety of pore formers. The extrudable mixture may use water or other fluid as its plasticizing agent, and may have other additives added. This flexibility in formation chemistry enables the extrudable mixture 52 to be advantageously used in many different types of applications. For example, mixture combinations may be selected according to required environmental, temperature, chemical, physical, or other requirement needs. Further, since extrudable mixture 52 is prepared for extrusion, the final extruded product may be flexibly and economically formed. Although not illustrated in FIG. 2, extrudable mixture 52 is extruded through a screw or piston extruder to form a green substrate, which is then cured into the final porous substrate product.

The present invention represents a pioneering use of fiber material in a plastic batch or mixture for extrusion. This fibrous extrudable mixture enables extrusion of substrates with very high porosities, at a scalable production, and in a cost-effective manner. By enabling fibers to be used in the repeatable and robust extrusion process, the present invention enables mass production of filters and catalytic substrates for wide use throughout the world.

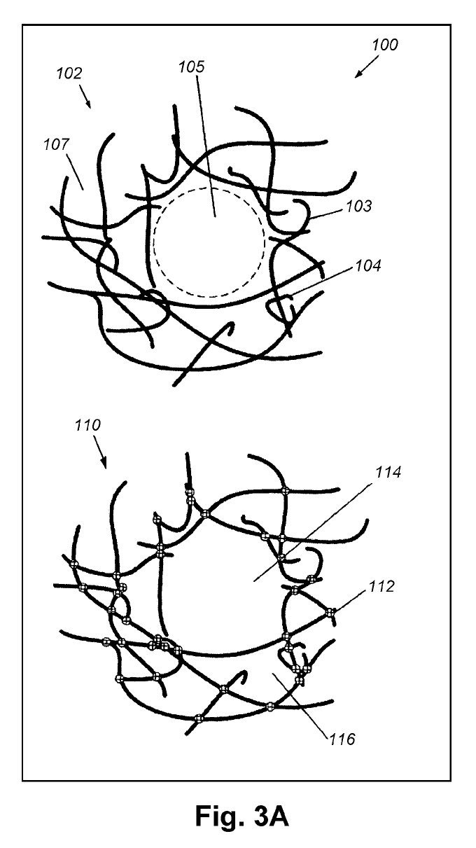

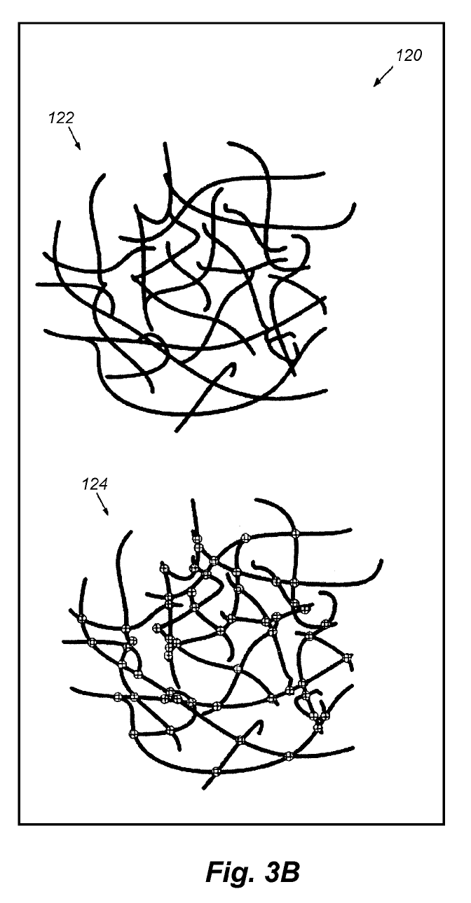

Referring to FIG. 3A, an enlarged cured area of a porous substrate is illustrated. The substrate portion 100 is illustrated after binder removal 102 and after the curing process 110. After binder removal 102, fibers, such as fiber 103 and 104 are initially held into position with binder material, and as the binder material burns off, the fibers are exposed to be in an overlapping, but loose, structure. Also, a pore former 105 may be positioned to produce additional open space, as well as to align or arrange fibers. Since the fibers only comprise a relatively small volume of the extrudable mixture, many open spaces 107 exist between the fibers. As the binder and pore former is burned off, the fibers may adjust slightly to further contact each other. The binder and pore formers are selected to burn off in a controlled manner so as not to disrupt the arrangement of the fibers or have the substrate collapse in burn off. Typically, the binder and pore formers are selected to degrade or burn off prior to forming bonds between the fibers. As the curing process continues, the overlapping and touching fibers begin to form bonds. It will be appreciated that the bonds may be formed in several ways. For example, the fibers may be heated to allow the formation of a liquid assisted sintered bond at the intersection or node of the fibers. This liquid state sintering may result from the particular fibers selected, or may result from additional additives added to the mixture or coated on the fibers. In other cases, it may be desirable to form a solid state sintered bond. In this case, the intersecting bonds form a grain structure connecting overlapping fibers. In the green state, the fibers have not yet formed physical bonds to one another, but may still exhibit some degree of green strength due to tangling of the fibers with one another. The particular type of bond selected will be dependent on selection of base materials, desired strength, and operating chemistries and environments. In some cases, the bonds are caused by the presence of inorganic binders presenting the mixture that hold the fibers together in a connected network. And do not burn off during the curing process.

Advantageously, the formation of bonds, such as bonds 112 facilitates forming a substantially rigid structure with the fibers. The bonds also enable the formation of an open pore network having very high porosity. For example, open-space 116 is created naturally by the space between fibers. Open space 114 is created as pore former 105 degrades or burns off. In this way, the fiber bond formation process creates an open pore network with no or virtually no terminated channels. This open pore network generates high permeability, high filtration efficiency, and allows high surface area for addition of catalyst, for example. It will be appreciated that the formation of bonds can depend upon the type of bond desired, such as solid-state or liquid-assisted/liquid-state sintering, and additives present during the curing process. For example, the additives, particular fiber selection, the time of heat, the level of heat, and the reaction environment may all be adjusted to create a particular type of bond.

Referring now to FIG. 3B, another enlarged cured area of a porous substrate is illustrated. The substrate portion 120 is illustrated after binder removal 122 and after the curing process 124. The substrate portion 120 is similar to the substrate portion 100 described with reference to FIG. 3A, so will not be described in detail. Substrate 120 has been formed without the use of specific pore formers, so the entire open pore network 124 has resulted from the positioning of the fibers with a binder material. In this way, moderately high porosity substrates may be formed without the use of any specific pore formers, thereby reducing the cost and complexity for manufacturing such moderate porosity substrates. It has been found that substrates having a porosity in the range of about 40% to about 60% may be produced in this way.

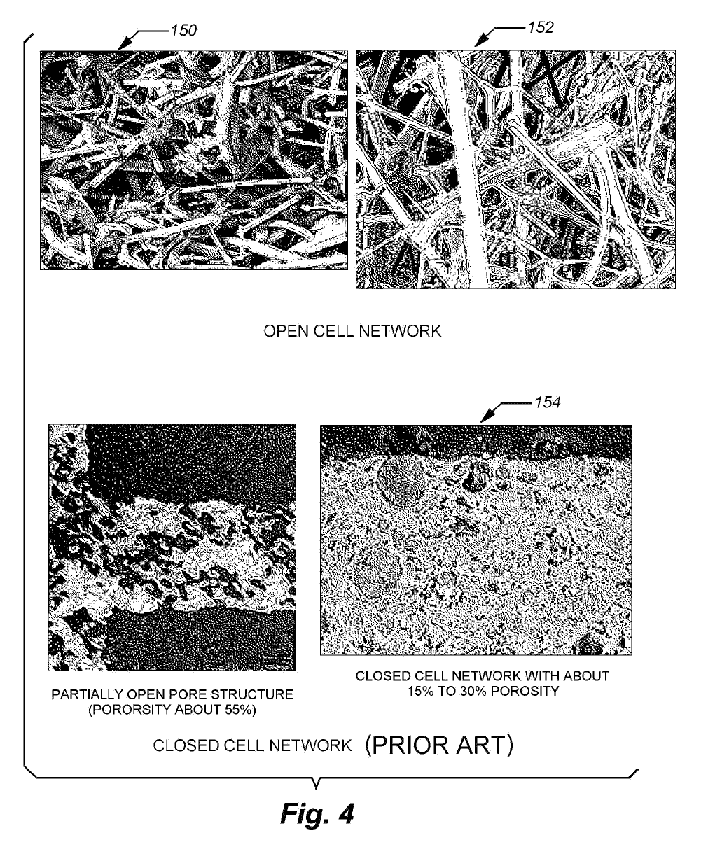

Referring now to FIG. 4, an electron microscope picture set 150 is illustrated. Picture set 150 first illustrates an open pore network 152 desirably created using a fibrous extrudable mixture. As can be seen, fibers have formed bonds at intersecting fiber nodes, and pore former and binders have been burned off, leaving a porous open pore network. In sharp contrast, picture 154 illustrates a typical closed cell network made using known processes. The partially closed pore network has a relatively high porosity, but at least some of the porosity is derived from closed channels. These closed channels do not contribute to permeability. In this way, an open pore network and a closed pore network having the same porosity, the open pore network will have a more desirable permeability characteristic.

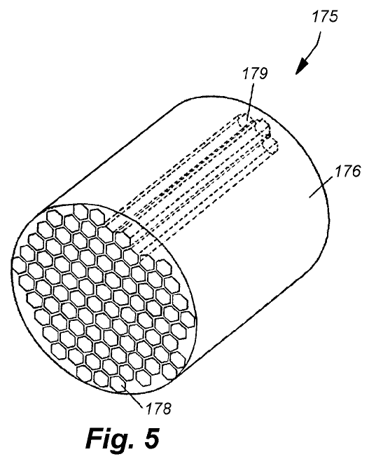

The extrudable mixture and process generally described thus far is used to produce a highly advantageous and porous substrate. In one example, the porous substrate may be extruded in to a filter block substrate 175 as illustrated in FIG. 5. Substrate block 175 has been extruded using a piston or screw extruder. The extruder could be conditioned to operate at room temperature, slightly elevated temperature or in a controlled temperature window. Additionally, several parts of the extruder could be cooled or heated to different temperatures to affect the flow characteristics, shear history, and gellation characteristics of the extrusion mix. Additionally, the size of the extrusion dies may also be sized accordingly to adjust the expected shrinkage in the substrate during the heating and sintering process. Advantageously, the extrudable mixture was a fibrous extrudable mixture having sufficient plasticizer and other additives to allow extrusion of fibrous material. The extruded green state block was cured to remove free water, burn off additives, and form structural bonds between fibers. The resulting block 175 has highly desirable porosity characteristics, as well as excellent permeability and high usable surface area. Also, depending on the particular fibers and additives selected, the block 175 may be constructed for advantageous depth filtering. The block 176 has channels 179 that extend longitudinally through the block. The inlets to the block 178 may be left open for a flow-through process, or every other opening may be plugged to produce a wall flow effect. Although block 175 is shown with hexagonal channels, it will be appreciated that other patterns and sizes may be used. For example, the channels may be formed with an evenly sized square, rectangular, or triangular channel pattern; a square/rectangular or octagon/square channel pattern having larger inlet channels; or in another symmetrical or asymmetrical channel pattern. The precise shapes and sizes of the channels or cells can be adjusted by adjusting the design of the die. For example, a square channel can be made to have curved corners by using EDM (Electronic Discharge Machining) to shape the pins in the die. Such rounded corners are expected to increase the strength of the final product, despite a slightly higher back-pressure. Additionally, die design can be modified to extrude honeycomb substrates where the walls have different thicknesses and the skin has a different thickness than the rest of the walls. Similarly, in some applications, an external skin may be applied to the extruded substrate for final definition of the size, shape, contour and strength.

When used as a flow-through device, the high porosity of block 176 enables a large surface area for the application of catalytic material. In this way, a highly effective and efficient catalytic converter may be made, with the converter having a low thermal mass. With such a low thermal mass, the resulting catalytic converter has good light off characteristics, and efficiently uses catalytic material. When used in a wall flow or wall filtering example, the high permeability of the substrate walls enable relatively low back pressures, while facilitating depth filtration. This depth filtration enables efficient particulate removal, as well as facilitates more effective regeneration. In wall-flow design, the fluid flowing through the substrate is forced to move through the walls of the substrate, hence enabling a more direct contact with the fibers making up the wall. Those fibers present a high surface area for potential reactions to take place, such as if a catalyst is present. Since the extrudable mixture may be formed from a wide variety of fibers, additives, and fluids, the chemistry of the extrudable mixture may be adjusted to generate a block having specific characteristics. For example, if the final block is desired to be a diesel particulate filter, the fibers are selected to account for safe operation even at the extreme temperature of an uncontrolled regeneration. In another example, if the block is going to be used to filter a particular type of exhaust gas, the fiber and bonds are selected so as not to react with the exhaust gas across the expected operational temperature range. Although the advantages of the high porosity substrate have been described with reference to filters and catalytic converters, it will be appreciated that many other applications exist for the highly porous substrate.

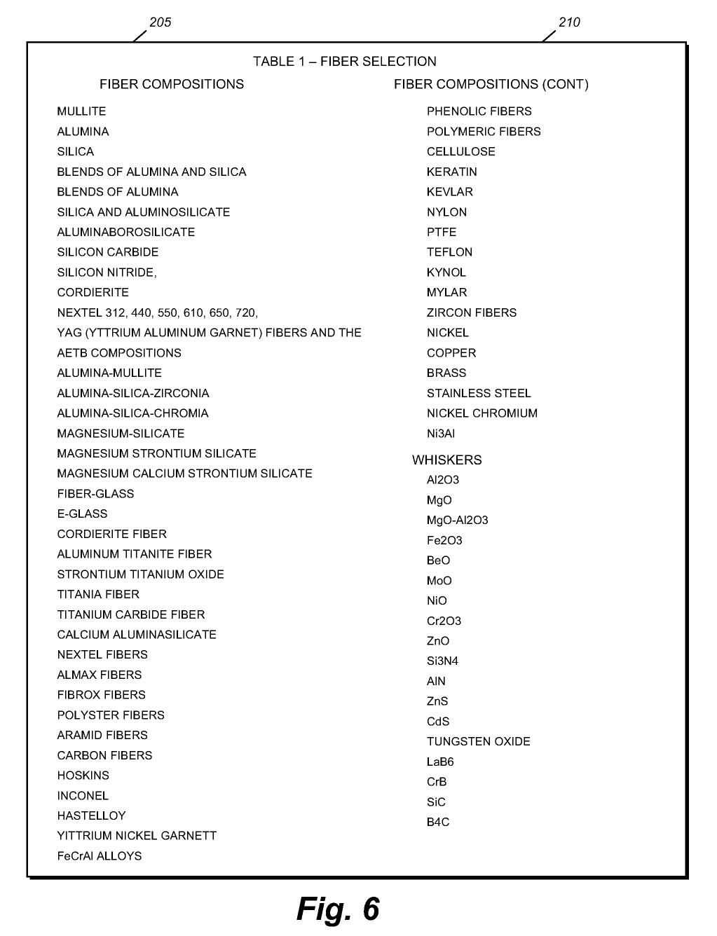

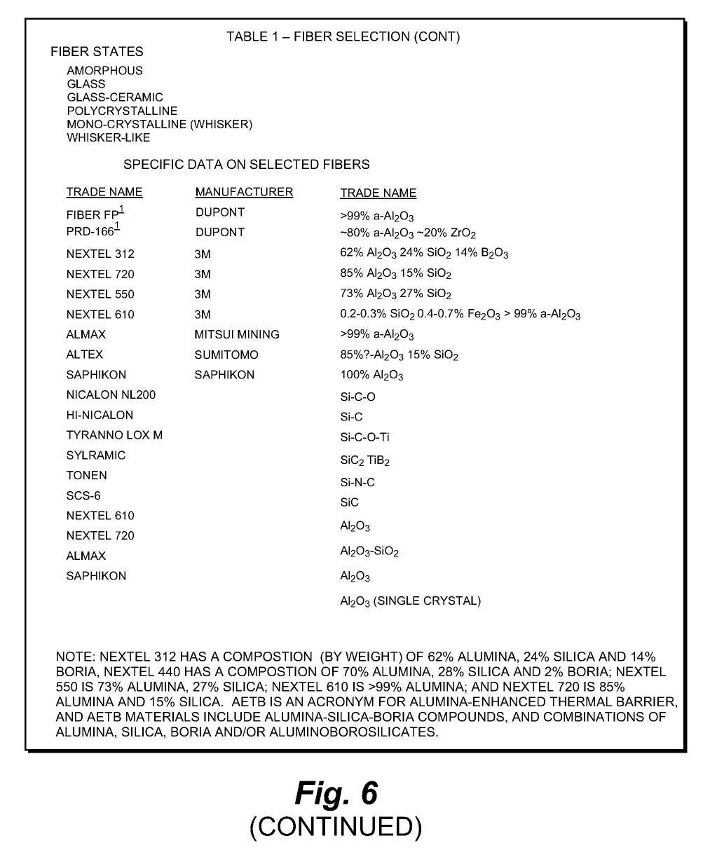

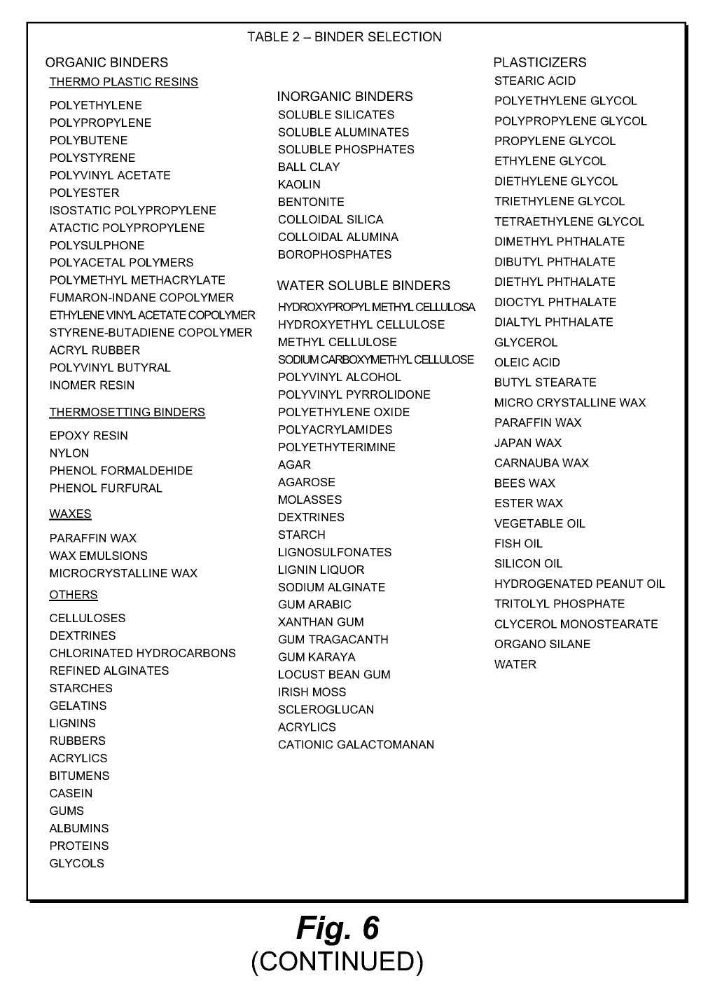

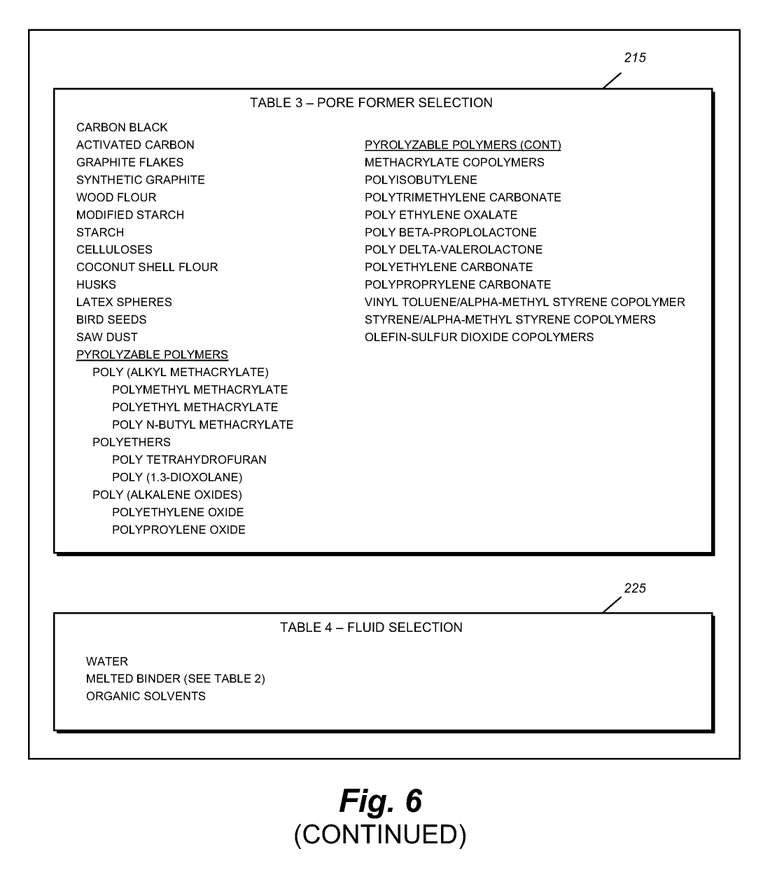

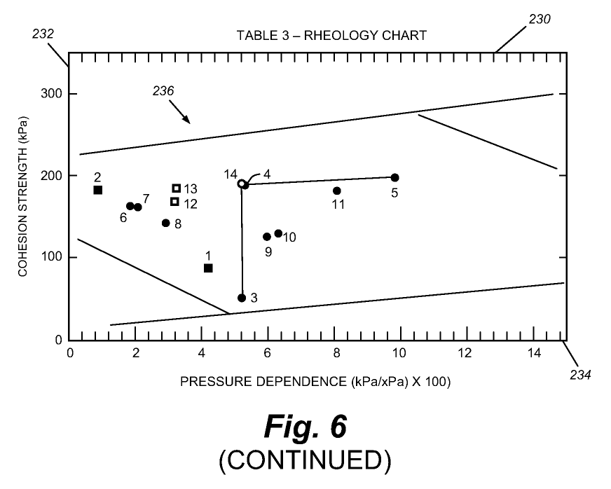

The fibrous extrudable mixture as described with reference to FIG. 2 may be formed from a wide variety of base materials. The selection of the proper materials is generally based on the chemical, mechanical, and environmental conditions that the final substrate must operate in. Accordingly, a first step in designing a porous substrate is to understand the final application for the substrate. Based on these requirements, particular fibers, binders, pore formers, fluids, and other materials may be selected. It will also be appreciated that the process applied to the selected materials may affect the final substrate product. Since the fiber is the primary structural material in the final substrate product, the selection of the fiber material is critical for enabling the final substrate to operate in its intended application. Accordingly, the fibers are selected according to the required bonding requirements, and a particular type of bonding process is selected. The bonding process may be a liquid state sintering, solid-state sintering, or a bonding requiring a bonding agent, such as glass-former, glass, clays, ceramics, ceramic precursors or colloidal sols. The bonding agent may be part of one of the fiber constructions, a coating on the fiber, or a component in one of the additives. It will also be appreciated that more than one type of fiber may be selected. It will also be appreciated that some fibers may be consumed during the curing and bonding process. In selecting the fiber composition, the final operating temperature is an important consideration, so that thermal stability of the fiber may be maintained. In another example, the fiber is selected so that it remains chemically inert and unreactive in the presence of expected gases, liquids, or solid particulate matter. The fiber may also be selected according to its cost, and some fibers may present health concerns due to their small sizes, and therefore their use may be avoided. Depending upon the mechanical environment, the fibers are selected according to their ability to form a strong rigid structure, as well as maintain the required mechanical integrity. It will be appreciated that the selection of an appropriate fiber or set of fibers may involve performance and application trade-offs. FIG. 6, Table 1, shows several types of fibers that may be used to form a fibrous extrudable mixture. Generally, the fibers may be oxide or non-oxide ceramic, glass, organic, inorganic, or they may be metallic. For ceramic materials, the fibers may be in different states, such as amorphous, vitreous, poly-crystalline or mono-crystalline. Although Table 1 illustrates many available fibers, it will be appreciated that other types of fibers may be used.

Binders and pore formers may then be selected according to the type of fibers selected, as well as other desired characteristics. In one example, the binder is selected to facilitate a particular type of liquid state bonding between the selected fibers. More particularly, the binder has a component, which at a bonding temperature, reacts to facilitate the flow of a liquid bond to the nodes of intersecting fibers. Also, the binder is selected for its ability to plasticize the selected fiber, as well as to maintain its green state strength. In one example, the binder is also selected according to the type of extrusion being used, and the required temperature for the extrusion. For example, some binders form a gelatinous mass when heated too much, and therefore may only be used in lower temperature extrusion processes. In another example, the binder may be selected according to its impact on shear mixing characteristics. In this way, the binder may facilitate chopping fibers to the desired aspect ratio during the mixing process. The binder may also be selected according to its degradation or burnoff characteristics. The binder needs to be able to hold the fibers generally into place, and not disrupt the forming fiber structure during burnoff. For example, if the binder burns off too rapidly or violently, the escaping gases may disrupt the forming structure. Also, the binder may be selected according to the amount of residue the binder leaves behind after burnout. Some applications may be highly sensitive to such residue.

Pore formers may not be needed for the formation of relatively moderate porosities. For example, the natural arrangement and packing of the fibers within the binder may cooperate to enable a porosity of about 40% to about 60%. In this way, a moderate porosity substrate may be generated using an extrusion process without the use of pore formers. In some cases, the elimination of pore formers enables a more economical porous substrate to be manufactured as compared to known processes. However, when a porosity of more than about 60% is required, pore formers may be used to cause additional airspace within the substrate after curing. The pore formers also may be selected according to their degradation or burnoff characteristics, and also may be selected according to their size and shape. Pore size may be important, for example, for trapping particular types of particulate matter, or for enabling particularly high permeability. The shape of the pores may also be adjusted, for example, to assist in proper alignment of the fibers. For example, a relatively elongated pore shape may arrange fibers into a more aligned pattern, while a more irregular or spherical shape may arrange the fibers into a more random pattern.

The fiber may be provided from a manufacturer as a chopped fiber, and used directly in the process, or a fiber may be provided in a bulk format, which is typically processed prior to use. Either way, process considerations should take into account how the fiber is to be processed into its final desirable aspect ratio distribution. Generally, the fiber is initially chopped prior to mixing with other additives, and then is further chopped during the mixing, shearing, and extrusion steps. However, extrusion can also be carried out with unchopped fibers by setting the rheology to make the extrusion mix extrudable at reasonable extrusion pressures and without causing dilatancy flows in the extrusion mix when placed under pressure at the extrusion die face. It will be appreciated that the chopping of fibers to the proper aspect ratio distribution may be done at various points in the overall process. Once the fiber has been selected and chopped to a usable length, it is mixed with the binder and pore former. This mixing may first be done in a dry form to initiate the mixing process, or may be done as a wet mix process. Fluid, which is typically water, is added to the mixture. In order to obtain the required level of homogeneous distribution, the mixture is shear mixed through one or more stages. The shear mixing or dispersive mixing provides a highly desirable homogeneous mixing process for evenly distributing the fibers in the mixture, as well as further cutting fibers to the desired aspect ratio.

FIG. 6 Table 2 shows several binders available for selection. It will be appreciated that a single binder may be used, or multiple binders may be used. The binders are generally divided into organic and inorganic classifications. The organic binders generally will burn off at a lower temperature during curing, while the inorganic binders will typically form a part of the final structure at a higher temperature. Although several binder selections are listed in Table 2, it will be appreciated that several other binders may be used. FIG. 6 Table 3 shows a list of pore formers available. Pore formers may be generally defined as organic or inorganic, with the organic typically burning off at a lower temperature than the inorganic. Although several pore formers are listed in Table 3, it will be appreciated that other pore formers may be used. FIG. 6 Table 4 shows different fluids that may be used. Although it will be appreciated that water may be the most economical and often used fluid, some applications may require other fluids. Although Table 4 shows several fluids that may be used, it will be appreciated that other fluids may be selected according to specific application and process requirements.

In general, the mixture may be adjusted to have a rheology appropriate for advantageous extrusion. Typically, proper rheology results from the proper selection and mixing of fibers, binders, dispersants, plasticizers, pore formers, and fluids. A high degree of mixing is needed to adequately provide plasticity to the fibers. Once the proper fiber, binder, and pore former have been selected, the amount of fluid is typically finally adjusted to meet the proper rheology. A proper rheology may be indicated, such as by one of two tests. The first test is a subjective, informal test where a bead of mixture is removed and formed between the fingers of a skilled extrusion operator. The operator is able to identify when the mixture properly slides between the fingers, indicating that the mixture is in a proper condition for extrusion. A second more objective test relies on measuring physical characteristics of the mixture. Generally, the shear strength versus compaction pressure can be measured using a confined (i.e. high pressure) annular rheometer. Measurements are taken and plotted according to a comparison of cohesion strength versus pressure dependence. By measuring the mixture at various mixtures and levels of fluid, a rheology chart identifying rheology points may be created. For example, Table 5 FIG. 6 illustrates a rheology chart for a fibrous ceramic mixture. Axis 232 represents cohesion strength and axis 234 represents pressure dependence. The extrudable area 236 represents an area where fibrous extrusion is highly likely to occur. Therefore, a mixture characterized by any measurement falling within area 236 is likely to successfully extrude. Of course, it will be appreciated that the rheology chart is subject to many variations, and so some variation in the positioning of area 236 is to be expected. Additionally, several other direct and indirect tests for measuring rheology and plasticity do exist, and it is appreciated that any number of them can be deployed to check if the mixture has the right rheology for it to be extruded into the final shape of the product desired.

Once the proper rheology has been reached, the mixture is extruded through an extruder. The extruder may be a piston extruder, a single screw extruder, or a twin screw extruder (described further below). The extruding process may be highly automated, or may require human intervention. The mixture is extruded through a die having the desired cross sectional shape for the substrate block. The die has been selected to sufficiently form the green substrate. In this way, a stable green substrate is created that may be handled through the curing process, while maintaining its shape and fiber alignment.

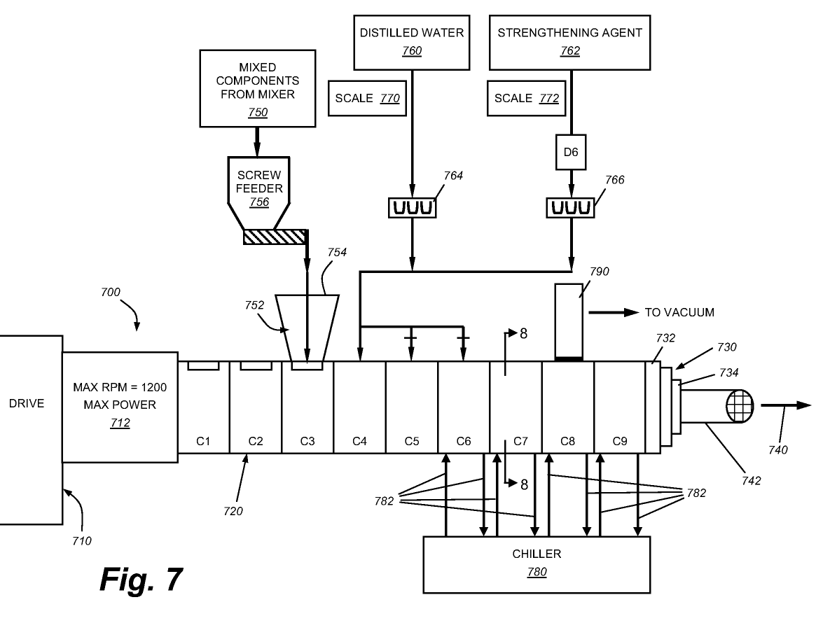

Reference is now made to FIG. 7, which shows a schematic representation of a twin screw extruder 700 for use in a system and method for forming fibrous porous ceramic substrates according to an illustrative embodiment of this invention. It is contemplated that a variety of shapes, sizes and arrangements of twin screw extruder can be employed according to this invention. In general, the twin screw extruder can be a convention, commercially available implementation, but custom attachments and parts can also be provided where and when appropriate. In this illustrative embodiment, the extruder 700 is a model ZSK40MC available from Coperion Werner & Pfleiderer GmbH & Co. KG of Stuttgart, Germany. This exemplary extruder includes a shaft barrel diameter of approximately 40 millimeters. Smaller or larger-diameters extruder barrels are expressly contemplated. A version of such a twin screw extruder is also shown and described in U.S. Pat. No. 6,179,460, entitled TWIN SCREW EXTRUDER WITH SINGLE-FLIGHT KNEADING DISKS by Burkhardt et al., the teachings of which are expressly incorporated herein by reference.

As shown in FIG. 7, the extruder 700 consists of a drive motor 710, powered by electricity, which rotates a gearbox or transmission 712 at the upstream end of a casing 720. As shown, the casing is constructed from a series of joined segments (C1-C9 in this illustrative embodiment). The segments C1-C9 are constructed from a hard, durable material, such as steel. The interior of the casing 720 is shown in cross section in FIG. 8. in general, the overall casing bore 810 defines the outline of figure-eight with a pair of parallel, cylindrical bores 812 and 814 that partially intersect due to the spacing SB between their central, longitudinal axes 822 and 824, respectively. The gearbox 712 is operatively connected to each of a pair of co-rotating keyed shafts 832, and 834 (having a cruciform key shape in this example) that each rotate about the respective axes 822, 824. The axes 822 and 824 are spaced apart at a spacing SB that results in the depicted overlap between bores 812, and 824. In this manner the elements mounted on each shaft 832, 834 can become intermeshed as the shafts rotate (arrows 840). In this depiction a pair of exemplary kneading blocks (cams) 852 and 854 are shown intermeshing. Cams, screw threads and other elements intermesh due to the synchronized timing of the shaft rotation and the fact that individual rotating elements are located at longitudinal offsets from each other, thereby preventing the elements from binding as they rotate into the central region 860 between bores 812, 814.

Referring further to FIG. 7, the extruder casing 720 extends downstream to a die head 730. The die head 730 is sized and arranged to eject (arrow 740) the desired continuous substrate shape 742. The die head 730 includes an appropriate “8-to-0” transition piece 732 between the casing 720 and the actual die 734. This allows the extruded mixture to transition from the figure-eight bore shape to a round (or other geometric) cross-section shape as defined by the die 734. The particular design of the die head 730 and its component parts is subject to variation based upon ordinary skill and the results of experimental observation.

The bore of the casing 720 and rotating shaft elements receive the blended mixture of substrate components 750 via a mixture feed port 752 that is located at segment C3 in this example. The feed port can include a hopper or other appropriate structure to ensure that the mixture 750 remains in engagement with the interior of the casing 720. In order to facilitate a continuous production process, the hopper 754 is fed a metered quantity of mixture 750 from a source (for example, a mixer described further below) using an illustrative screw feeder 756 or other metering device. The feed rate is determined by the amount of mixture that is needed to generate a finished green substrate 742 free of voids and other imperfections.

Notably, the mixture 750 of the illustrative embodiment is dry, containing no added water or other liquid solvents when delivered to the hopper 754. When employing a piston extruder, the mixture batch is illustratively provided in a wet form after being mixed with, for example, a commercially available S-blade mixer in which fluid (water) is provided during the mixing phase. A moistened mixture can be provided to feed continuously into the twin screw extruder 700, though the wet mixture, once fed may exhibit a propensity to not transport properly through the extruder without clumping and chunking. Thus, the dry mixture 750 is fed to the screws where it passes downstream into the various segments of the casing 720, within which fluid (distilled water) 760 combined with a substrate strengthening agent 762 (for example, colloidal silica solution) are added through ports in segments C4, C5 and C6. The location of fluid addition is highly variable. In this embodiment it is sufficiently downstream of the mixture entry port 752 so as to prevent upstream migration of fluid, which could cause clumping of the admitted mixture 750. Note that upstream segments C1 and C2 are provided to catch and redirect mixture into the downstream direction.

The fluid 760 and strengthening agent 762 (also termed a bonding phase, as it sinters fibers together under high temperature curing) are provided in metered quantities to the casing 720 using pump/valve assemblies 764 and 766, respectively. In the depicted arrangement scales 770, 772 that respectively measure the weight of each liquid component 760, 762 can also be provided. These scales 770, 772 can be monitored to control flow and indicate remaining fluid quantity. A variety of flow and capacity-monitoring devices can be employed in alternate embodiments in a manner that should be apparent to those of ordinary skill. As will be described below, the screw shafts each include a plurality of sections along their lengths. The sections are either screw threads that drive the mixture downstream or kneading blocks induce shear into the mixture so as to further mix and homogenize the mixture with the added liquids. The placement of threads and kneading blocks, as well at the lengths and pitch of particular sections thereof, is described further below.

Because the transport, kneading and substrate-formation/extrusion processes generate heat, it is desirable to maintain the temperature within the casing at a relatively constant and low (room temperature, for example) level. Excess heat can reduce substrate strength due to premature curing of the material. A chilled coolant circulating system 780 is provided to circulate (two-way arrows 782) liquid coolant (water, or polyethylene glycol, for example) through the casing within segments C6-C9 in this embodiment. The cooling system can include an outer jacket assembly (not shown) that covers the affected segments, or the segment can be provided with internal cooling channels (also not shown), which are accessed by taps on the exterior surface of the casing. A variety of cooling/heat-transfer mechanisms and techniques can be employed within the scope of ordinary skill.

Just prior to the die head 730, the pressure within the mixture may reach in excess of 1000 psi. It is desirable to remove a predetermined quantity of air from the material to ensure it exits the die substantially free of air bubbles. Such air bubbles can form voids in the cured substrate and weaken its structure. Thus, a vacuum is applied to segment C8 in this embodiment, though a vacuum can be alternatively applied at other segments. The vacuum is applied through a vacuum vent stuffer 790 of conventional design, thereby preventing material from migrating through the vacuum port while also preventing clogging of the port. The level of vacuum applied to the mixture, and location of the vacuum along the casing 720 can be varied experimentally to achieve the desired degree of de-airing.

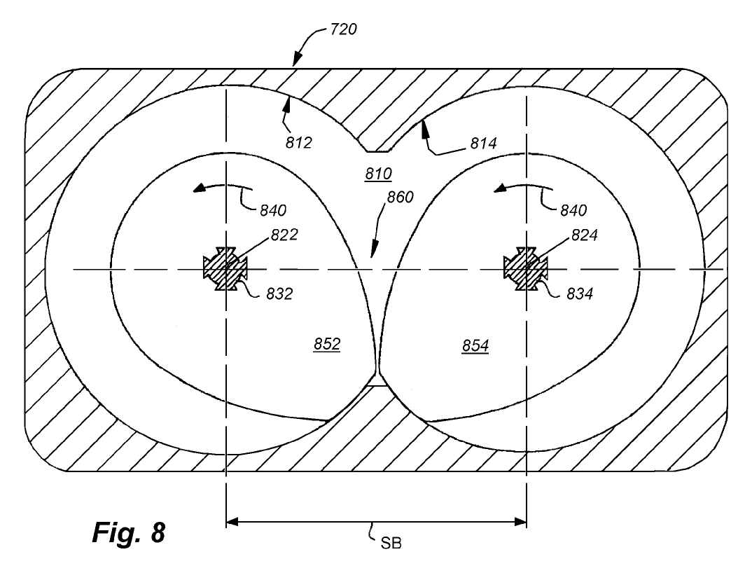

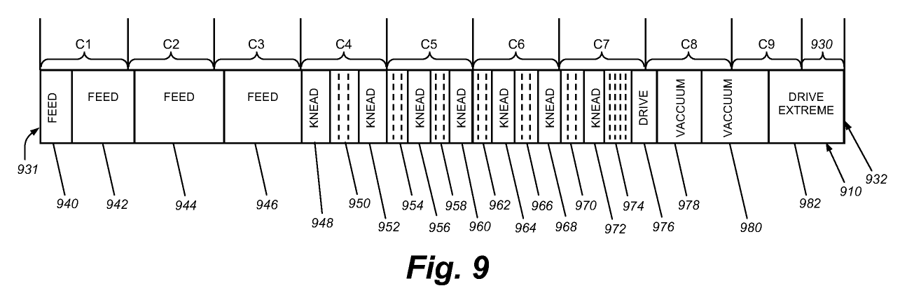

Reference is now made to FIG. 9, which shows an illustrative arrangement for the sectional elements of a screw shaft 910 (one of an identical pair of screw shafts) for use in the extruder casing 900. It should be noted that the exemplary arrangement is one of a wide variety of possible arrangements that can be implemented in accordance with ordinary skill and based upon the outcome of trial-and-error experimentation with various arrangements. The screw shaft 910 is shown with respect to a further schematisized diagram of the exemplary segments C1-C9 and die head 930 of the casing 920 so that relative locations of various shaft sections can be ascertained.

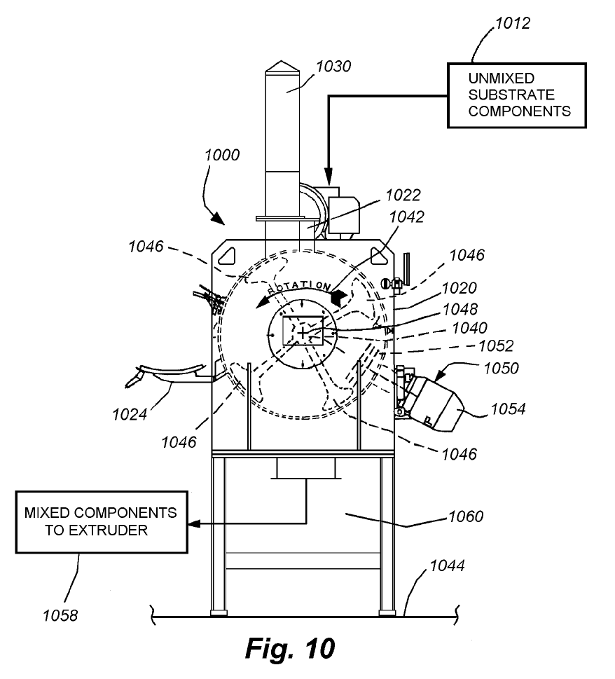

It should also be noted that typical shafts consist of a hardened central core (1032, 1034 in FIG. 10) that can include a keyed or splined surface so that any components attached thereto are restricted from rotating relative to the shaft core. The core is a continuous shape along its length so that section components can be slid down the shaft to the appropriate location along its length. The ends of the shaft can be blocked with bolts, cotters and or other stopping structures that prevent section components from sliding away from the shaft once it is assembled. The shaft structure enables the operator to change the overall layout of shaft sections relatively easily to apply different degrees of transport speed, drive pressure and kneading as desired.

The illustrative shaft 910 is arranged in a plurality of screw transport and kneading elements between its upstream-most end 930, adjacent to segment C1 and the extruder drive and its downstream-most end 932, adjacent to the die head 930. More generally, the screw transport section elements, between kneading elements have particular pitch values and other characteristics that are adapted to the stage of the process within the extruder. Hence, transport screw elements associated with feeding of mixture are identified as FEED, those associated with shear-inducing mixing or kneading of the mixture with fluid are identified as KNEAD, bridging transport elements are denoted generally as DRIVE, elements associated with the vacuum section are denoted as VACUUM and downstream-most sections that direct the material under pressure to the die are denoted EXTRUDE.

The first three FEED elements (taken upstream-to-downstream) consist of a closely spaced screw thread section 940, a wider-spaced (coarser-pitch) screw section 942 and another closely spaced section 944. The screw section 944 extends slightly into the feed segment C3. One of ordinary skill should recognize that these sections assist in guiding material back from the upstream end, and into the downstream segments beyond the feed segment C3. A coarser-pitch FEED screw element 946 resides within the remaining portion of the feed segment C3. A shorter, slightly closer-spaced (finer-pitched) screw (KNEAD) element 948 extends into segment C4 (the first fluid-addition segment). This section 948 joins to the first set of kneading blocks 950. At this location, where fluid is added, the fluid and dry components are initially kneaded together, and the shaft alternates between appropriate-length transport sections and shear-inducing, kneading block sections. In this example, following, the short screw (KNEAD) element 952 (with a similar pitch to screw element 948) separates the blocks 950 from a second set of kneading blocks 954 that extends into segment C5 (the second fluid-addition section). A further short screw (KNEAD) element 956 joins another set of kneading blocks 958 within segment C5. Another short screw (KNEAD) element 960 bridges between the segment C5 and segment C6 (the third fluid-addition segment). This screw (KNEAD element 960 is joined to another set of kneading blocks 962, followed thereafter by another screw (KNEAD) element 964 and kneading blocks 966. A finer-pitch screw (KNEAD) element 968 extends into segment C7, and joins to a further set of kneading blocks 970. These blocks are joined to another finer-pitch screw element 972, which leads to a longer, and final, set of kneading blocks 974 that completes the shear-inducement to the mixture. Another shortened, finer-pitch screw (DRIVE) element 976 extends into segment C8 (the vacuum segment). Thereafter a coarser-pitch screw (VACUUM) element 978, finer-pitch screw (VACUUM) element 980 and final, coarser-pitch screw (DRIVE/EXTRUDE) element complete the shaft (in segment C9 and die head 930). The region around the vacuum generally includes a coarser pitch, in part, to slow transport of material so that the vacuum may act upon the mixture for an extend time period. The pitch of the screw element in this region determines the duration of the material under vacuum, thereby allowing more air bubbles to be removed from the kneaded, wetted mixture. Note that the final segment includes a longitudinally thickened thread apex to resist the high pressures imparted in the material at the die head 930.

According to this embodiment, the screw shaft is arranged in upstream-to-downstream stages that allow the mixture to move from a feed location to the die, at a given speed and pressure with a predetermined level of shear-kneading thereto. The stages include a feed transport section, alternating kneading and transport with application of fluid, vacuum de-airing during a predetermined transport interval and pressure buildup at the die head for adequate extrusion.

As described above, the system and method for twin screw extrusion of this embodiment employs a mixture of substrate components that is free of fluid (water) when initially fed to the extruder 900. Hence the mixture can be defined as a dry homogeneous mixture containing fibers, binding agents and pore former. The subsequently applied fluid mixture in this embodiment includes a colloidal suspension of the glass strengthening agent, but in alternate embodiments, the glass can also be provided as a dry component in the initial homogeneous mixture. The homogeneous mixture can be thoroughly blended prior to feeding the mixture to the extruder. FIG. 10 is a frontal view of an exemplary industrial mixer 1000 for blending dry substrate components used with the system and method of this invention. Note that it is expressly contemplated that a variety of types, arrangements and capacity levels of mixers can be employed in alternate embodiments. This mixer is therefore described by way of example.

The mixer 1000 is a horizontal plow type mixer. It includes a mixing barrel 1020 in which components are provided for mixing. An upper charging port 1022 allows unmixed material 1012 to be fed from a transport conduit or feed chute. Since fibrous mullite tends to form a matted surface due to the intertangling of fibers, it may need to be inserted through one or more of the enlarged-opening, hinged side doors 1024 in the barrel 1020. Alternately, the mullite fibers can be prechopped to more-reliably feed into the port 1022. A vent stack 1030 is provided to balance pressure within the barrel 1020 during mixing in this example. The illustrative mixer contains a central axle 1040 (shown in phantom) that extends longitudinally (along a horizontal rotation axis 1048, parallel to the ground 1044) through the barrel 1020, and is rotated (arrow 1042) by a drive motor (not shown) at one end of the mixer 1000. The axle carries a set of radially and longitudinally spaced blades 1046 (shown in phantom) that create a mechanical fluidized bed mixing action. The mixing blades project and hurl substrate component material away from the wall into free space in a crisscross direction, and inversely back again. The size, number, geometric shape, arrangement, and peripheral speed of the mixing blades can be customized in accordance with manufacturer specifications and experimentation to achieve the desired mixing action. The plow blades also separate and lift the material into three-dimensional motion, while the number and arrangement of the tools insure agitation back and forth along the length of the barrel. In the illustrative example, the mix action is assisted by a high shear chopper device 1050, using an independent high-speed motor 1054 with a stack of customized chopper blades 1052 (shown in phantom) for adding shear to the mixture.

The depicted exemplary mixer 1000 is part of the FKM series available Littleford Day, Inc. of Florence, Ky. The KM series can also be employed, and is particularly suited to a continuous feed operation. Where continuous feed is employed, the ratios of components entering the charge port of the mixer should be adequately regulated using scales or other flow-control devices. By use of the exemplary mixer 1000, the blended mixture exhibits thorough dispersion of all ingredients and a homogenous mix, regardless of differences in raw material densities and/or particle size. When mixing is complete, the blended mixture 1058 is discharged through a bottom discharge port 1060. The mixture can then be automatically or manually conveyed (continuously or in batch form) to the extruder 900. The duration of a given quantity or batch of mixture components within the mixer is highly variable. In an illustrative embodiment, the duration can be between approximately 5 and 15 minutes—however other durations can be employed to achieve successful homogenization of components.

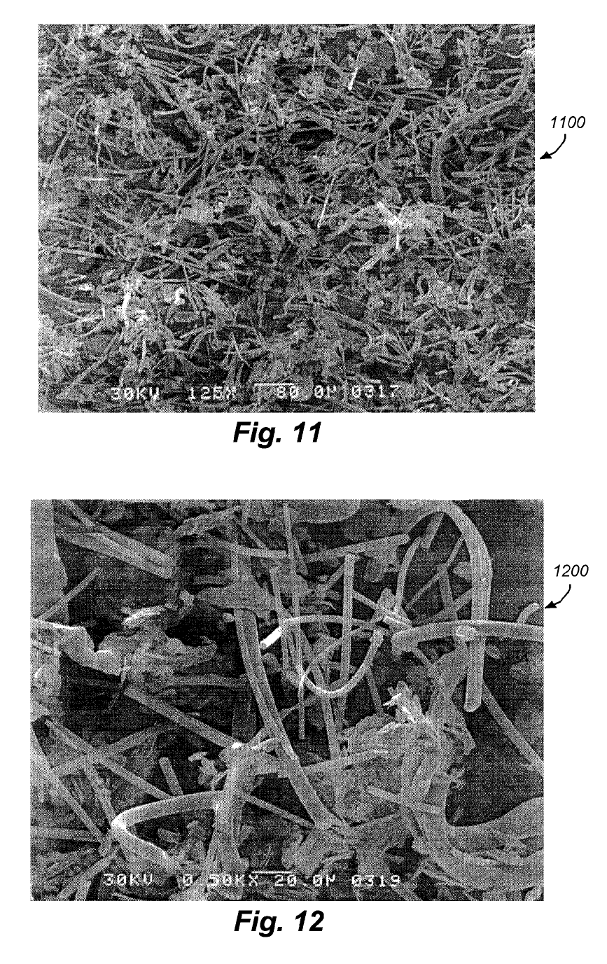

Based upon experimental results using a mixture of mullite, binder (HPMC in this example) and bentonite (a strengthening agent) in the ratios that are approximately equivalent to those listed in the table first illustrative example) below, a blended mixture of substrate components as depicted in the electron micrographs of FIGS. 11 and 12. As shown in the lower magnification view 1100 (FIG. 11), the mixture appears highly blended, with fibrous and granular materials well dispersed. In the magnified view 1200 of FIG. 12, the dispersal is still fairly homogeneous. Notably, the characteristic clumping that is exhibited by fibers is not present. Thus, when the dry mixture is admitted to the extruder 700, it exhibits a high level of dispersal, before fluid is added. As will be discussed below, this may advantageously affect the porosity and strength of the substrate.

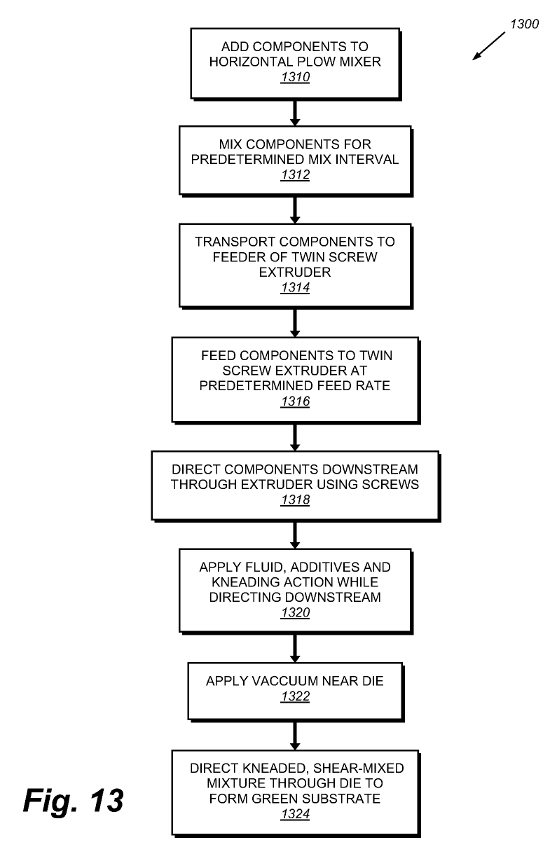

Reference is now made to FIG. 13, which shows an illustrative procedure 1300 for extruding a fibrous porous ceramic substrate in accordance with the twin screw extrusion embodiment of this invention. In particular, the process 1300 begins with the addition of individual, dry material components comprising at least 30% fiber material by weight, to the above-described, exemplary mixer 1000 (step 1310). The substrate mixture components are then mixed for a predetermined time interval in the mixer 1000 (step 1312) until the desired level of homogeneity is achieved within the blended mixture. The mixing can occur in batch form with a single predetermined quantity of each component mixed in one cycle of the mixer's operation, which is then delivered to the feeder 752 of the extruder 700. Alternatively, the mixing can comprise a continuous feed (at an appropriate rate) of appropriate ratios of the dry components to the mixer, for delivery at a predetermined transport rate to the extruder's feeder 756 (step 1314). The components are then fed by the feeder 756 to the fed port of the extruder 700. In the illustrative example, a feed rate of up to approximately 36 lbs of material per hour (pph) are fed to the exemplary extruder 700. This material feed rate can be varied based (in part) upon the volume of the extruder being employed. The feeder 756 in this example is a model T-35 feeder (available from K-Tron International, Inc. of Pitman, N.J.), including twin wide-pitch concave feed screws with a 4-bladed auger and bin auger. According to the specified feed rate, the feeder 756 regulated application of the pre-mixed blend of components to the extruder feed port 752 (step 1316).

The fed, pre-blended mixture is then directed through the extruder 700 beginning with a screw drive section of the shafts that ensures the mixture is downstream of any feed port opening so that the mixture can begin to experience a downstream driving bias (step 1318). As the mixture is driven by the screws through various segments of the extruder casing, distilled water and colloidal silica (in this illustrative embodiment) are applied. This causes the mixture to become a viscous paste of appropriate consistency. Mixture is enhanced by the periodic application of kneading action as the now-wet mixture travels downstream through a succession of kneading blocks where shear is introduced and the mixture becomes homogenized with the appropriate level of moisture. Since the pre-mixed dry material blend is already relatively well-homogenized (with respect to its dry components), the kneading blocks mainly assist in further mixing-in the water and suspended colloidal components thereof (step 1320). After sufficient mixing has occurred, the vacuum (790) is applied to the mixture, just prior to the pressurable direction of the mixture through the extrusion die head 730 (step 1322). At this point, the kneaded, shear-mixed mixture is forced through the die to form a green substrate (step 1324). In an exemplary embodiment, a 40-Mesh Screen is provided at the die head to restrict passage of oversized clumps or foreign materials therethrough. By proper arrangement of components and screw/kneader elements, the screen can be omitted.

In an experimental arrangement—the parameters of which are highly variable—an amount of fluid (distilled water with 6-7 weight percent colloidal silica) equally to approximately 26-31 percent by weight is employed. The extruder shafts are rotated at approximately 30-40 rpm and the discharge temperature of the die head remains below approximately 30 C, while the discharge pressure is approximately 600-900 psi. The vacuum level is set between approximately −20 to −30 inches Hg. A 3-inch square die is employed and a 30 mm 8-0 section bridges the location between the end of the shafts (the 8-shape) and the die (the 0-shape). The resulting extruded green substrate exhibited a continuous shape with molded honeycomb cross-sectional structure intact, being largely free of voids and cavities. After drying curing (in a manner generally described below), the completed substrate exhibited a porosity of approximately 69-70% and a crush strength of approximately 300-400 psi.

It is contemplated that substrate crush strength may be improved according to further exemplary embodiments by reducing the HPMC provided in the mixture—as well as adjustment of other mixture component ratios—including, but not limited to, the ratio of strengthening agents. In addition, larger dies, such as a 144-millimeter round die, may be employed with an appropriately sized extruder barrel to increase production speed and allow formation of a large-diameter, more-uniform substrate. To this end, the 8-0 transition between the end of the shafts and the die can be modified to compensate for the sideways bias in the extrudate caused by the co-rotation of the shafts—in other words, the shaft rotation causes the mixture to lean to one side of the die. One possible shape comprises a narrowing of the screw-to-die transition's throat and a subsequent, downstream widening to the die diameter. In addition, the location of the vacuum can be moved closer to the die head with associated screw pitch to control the duration of mixture exposure to the vacuum.

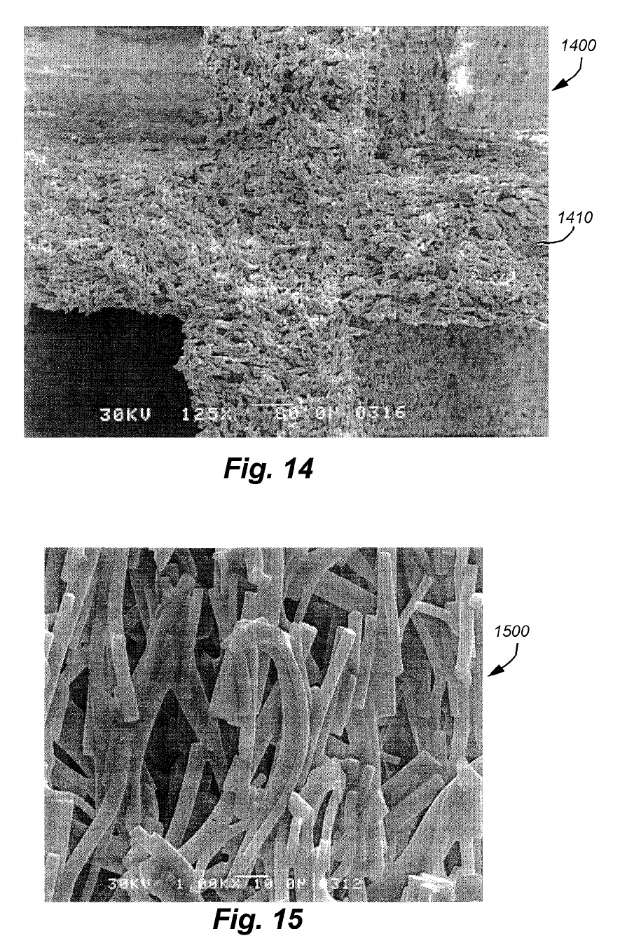

The above-described experimental procedures, relative to a mullite-based fibrous compound extruded using a twin screw extruder, a dried and cured substrate (the drying and curing steps being described below), yields a substrate having a porous structure as shown in the electron micrographs of FIGS. 14 and 15. In the view 1400 of FIG. 14, the transition between the walls 1410 of the honeycomb structure are clearly delineated—thereby indicating successful formation of the desired extruded shape by the twin screw procedure of this embodiment. Likewise a largely uniform fibrous structure appears to be present. In the magnified view 1500 of FIG. 15, the fibers appear unclumped and well-fused—generally desirable properties in a substrate.

It is expressly contemplated that the twin screw extrusion procedure 1300 of FIG. 13 can be applied to other types of material mixtures, where a combination of components including at least 20% fiber materials by volume can be mixed as a dry mixture and then wetted by appropriate levels of fluid to provide the desired rheology to the kneaded mixture within the extruder. For example, bonded silicon carbide-based substrate materials can be mixed in dry form and provided to the twin-screw extruder for subsequent application of fluid in an alternate embodiment. In another embodiment, at least 25% fiber materials by volume can be mixed as a dry mixture and then wetted by appropriate levels of fluid to provide the desired rheology to the kneaded mixture within the extruder. In yet further embodiments, fiber materials in 30%, 35%, 40% by volume respectively can be mixed as a dry mixture and then wetted by appropriate levels of fluid to provide the desired rheology to the kneaded mixture within the extruder.

More particularly, an exemplary reaction-bonded SiC mixture can be used in conjunction with the illustrative twin screw extrusion procedure. This mixture forms silicon carbide fibers from carbon fibers, combining at high temperature with silicon metal to produce a matrix of fused silicon carbide. Such a mixture can comprise the following components (the fluid being added during extrusion):

| | | Vol (cc) | % Vol (Dry) |
|---|---|---|---|
| Fiber | Carbon Fiber | 2046 | 20.19% |
| Strengthener | Silicon Powder | 5258 | 51.90% |
| | Bentonite | 519 | 5.13% |
| Binder | HPMC | 2308 | 22.78% |
| Fluid | Water (during extrusion step) | 9150 | |

With respect to the above-described procedures for forming a green substrate, the subsequent drying and curing processes occur according to the below-described illustrative steps. The drying can take place in room conditions, in controlled temperature and humidity conditions (such as in controlled ovens), in microwave ovens, RF ovens, and convection ovens. Curing generally requires the removal of free water to dry the green substrate. It is important to dry the green substrate in a controlled manner so as not to introduce cracks or other structural defects. The temperature may then be raised to burn off additives, such as binders and pore formers. The temperature is controlled to assure the additives are burned off in a controlled manner. It will be appreciated that additive burn off may require cycling of temperatures through various timed cycles and various levels of heat. Once the additives are burned off, the substrate is heated to the required temperature to form structural bonds at fiber intersection points or nodes. The required temperature is selected according to the type of bond required and the chemistry of the fibers. For example, liquid-assisted sintered bonds are typically formed at a temperature lower than solid state bonds. It will also be appreciated that the amount of time at the bonding temperature may be adjusted according to the specific type of bond being produced. The entire thermal cycle can be performed in the same furnace, in different furnaces, in batch or continuous processes and in air or controlled atmosphere conditions. After the fiber bonds have been formed, the substrate is slowly cooled down to room temperature. It will be appreciated that the curing process may be accomplished in one oven or multiple ovens/furnaces, and may be automated in a production ovens/furnaces, such as tunnel kilns.

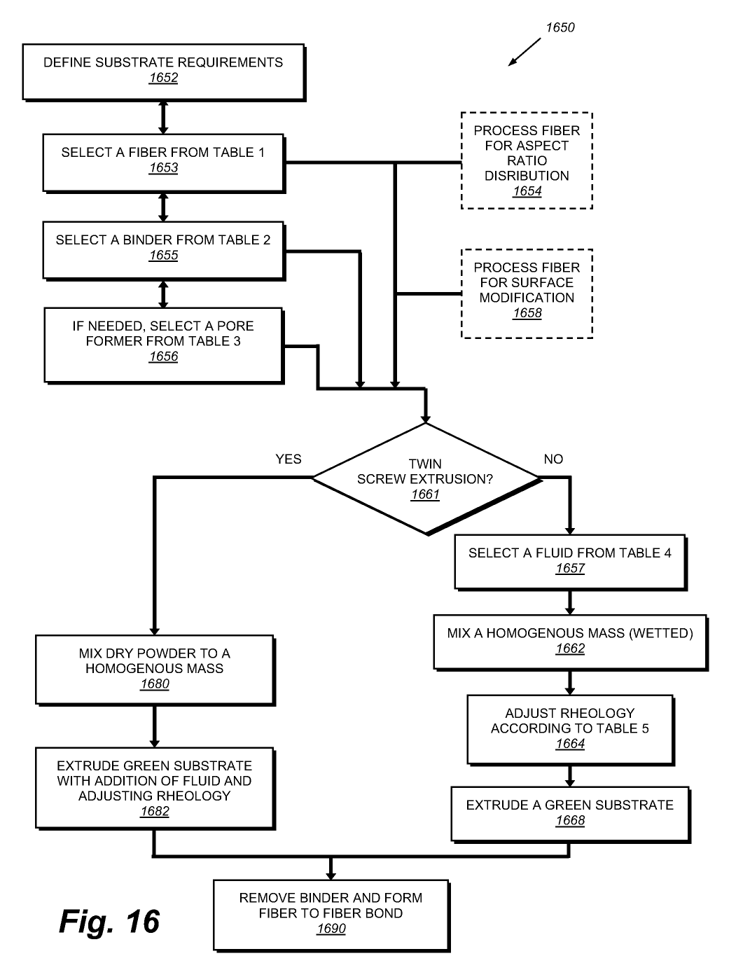

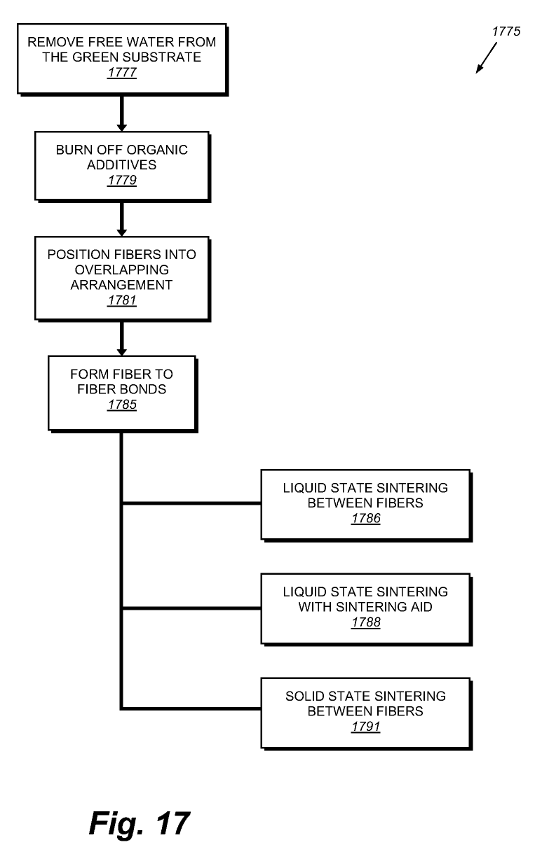

Referring now to FIG. 16, an overall system and method 1650 for extruding a porous substrate is illustrated. This system and method 1650 is a highly flexible process for producing a porous substrate. It applies to either a piston-based extrusion process (using a wetted mixture), a screw-based—and illustratively twin screw-based—extrusion process (using a dry mixture and fluid applied during extrusion within the barrel casing), or any other operative extrusion process. In order to design the substrate, the substrate requirements are defined as shown in block 1652. For example, the final use of the substrate generally defines the substrate requirements, which may include size constraints, temperature constraints, strength constraints, and chemical reaction constraints. Further, the cost and mass manufacturability of the substrate may determine and drive certain selections. For example, a high production rate may entail the generation of relatively high temperatures in the extrusion die, and therefore binders are selected that operate at an elevated temperature without hardening or gelling. In extrusions using high temperature binders, the dies and barrel may need to be maintained at a relatively higher temperature such as 60 to 180 C. In such a case, the binder may melt, reducing or eliminating the need for additional fluid. In another example, a filter may be designed to trap particulate matter, so the fiber is selected to remain unreactive with the particulate matter even at elevated temperatures. It will be appreciated that a wide range of applications may be accommodated, with a wide range of possible mixtures and processes. One skilled in the art will appreciate the trade-offs involved in the selection of fibers, binders, pore formers, fluids, and process steps. Indeed, one of the significant advantages of system and method 1650 is its flexibility as to the selection of mixture composition and the adjustments to the processes.

Once the substrate requirements have been defined, a fiber is selected from Table 1 of FIG. 6 as shown in block 163. The fiber may be of a single type, or may be a combination of two or more types. It will also be appreciated that some fibers may be selected to be consumed during the curing process. Also, additives may be added to the fibers, such as coatings on the fibers, to introduce other materials into the mixture. For example, dispersant agents may be applied to fibers to facilitate separation and arrangement of fibers, or bonding aids may be coated onto the fibers. In the case of bonding aids, when the fibers reach curing temperatures, the bonding aids assist the formation and flowing of liquid state bonds.

A first illustrative example composition can be used to provide a porous substrate having a porosity of approximately 60% with at least 40% fiber by volume:

| | | Vol (cc) | % Vol (Dry) |
|---|---|---|---|
| Fiber | Mullite Fiber | 5556 | 42.55 |
| Strengthener | Bentonite | 520 | 3.98 |
| | Colloidal Silica | 1023 | 7.83 |
| Pore Former | Carbon (Graphite) Particles | 2727 | 20.89 |
| Binder | HPMC | 3231 | 24.75 |
| Fluid | Water (during extrusion step) | 12900 | |

In this example, dry ingredients that can be pre-blended are the mullite fiber, bentonite, HPMC and graphite. The liquid ingredients include the colloidal silica (50% solids in a water solution) and the water.

A second illustrative example composition can be used to provide a porous substrate having greater than 60% porosity with at least 25% fiber by volume:

| | | Vol (cc) | % Vol (Dry) |
|---|---|---|---|
| Fiber | Mullite Fiber | 4074 | 27.79 |
| Strengthener | Bentonite | 381 | 2.60 |
| | Colloidal Silica | 1000 | 6.82 |
| Pore Former | Carbon (Graphite) Particles | 6500 | 44.33 |
| Binder | HPMC | 2708 | 18.47 |
| Fluid | Water (during extrusion step) | 13530 | |

In this example, dry ingredients that can be pre-blended are the mullite fiber, bentonite, HPMC and graphite. The liquid ingredients include the colloidal silica (50% solids in a water solution) and the water.

A third illustrative example composition can be used to provide a porous substrate having greater than 60% porosity, by increasing the amount of pore former with at least 20% fiber by volume:

| | | Vol (cc) | % Vol (Dry) |
|---|---|---|---|
| Fiber | Mullite Fiber | 4074 | 24.65 |
| Strengthener | Bentonite | 381 | 2.30 |
| | Colloidal Silica | 1000 | 6.05 |
| Pore Former | Carbon (Graphite) Particles | 8364 | 50.61 |
| Binder | HPMC | 2708 | 16.38 |
| Fluid | Water (during extrusion step) | 13530 | |

In this example, the dry ingredients include the mullite fiber, bentonite, HPMC and graphite. The liquid ingredients include the colloidal silica (50% solids in a water solution) and the water.

A binder is then selected from Table 2 of FIG. 6 as shown in block 1655. The binder is selected to facilitate green state strength, as well as controlled burn off. Also, the binder is selected to produce sufficient plasticity in the mixture. If needed, a pore former is selected from Table 3 of FIG. 6 as shown in block 1656. In some cases, sufficient porosity may be obtained through the use of fibers and binders only. The porosity is achieved not only by the natural packing characteristics of the fibers, but also by the space occupied by the binders, solvents and other volatile components which are released during the de-binding and curing stages. To achieve higher porosities, additional pore formers may be added. Pore formers are also selected according to their controlled burn off capabilities, and may also assist in plasticizing the mixture.

In the case of a wetted mixture, used, for example in a piston-type extruder, the decision block 1661 directs the system and method to block 1657 wherein fluid, which is typically water, is selected from Table 4 FIG. 6 as shown in block 1657. Other liquid materials may be added, such as a dispersant, for assisting in separation and arrangement of fibers, and plasticizers and extrusion aids for improving flow behavior of the mixture. This dispersant may be used to adjust the surface electronic charges on the fibers. In this way, fibers may have their charge controlled to cause individual fibers to repel each other. This facilitates a more homogeneous and random distribution of fibers. A typical composition for mixture intended to create a substrate with >80% porosity is shown below. It will be appreciated that the mixture may be adjusted according to target porosity, the specific application, and process considerations.

As shown in block 1654, the fibers selected in block 1652 can be processed to have a proper aspect ratio distribution. This aspect ratio is preferred to be in the range of about 3 to about 500 and may have one or more modes of distribution. It will be appreciated that other ranges may be selected, for example, to about an aspect ratio of 1000. In one example, the distribution of aspect ratios may be randomly distributed throughout the desired range, and in other examples the aspect ratios may be selected at more discrete mode values. It has been found that the aspect ratio is an important factor in defining the packing characteristics for the fibers. Accordingly, the aspect ratio and distribution of aspect ratios is selected to implement a particular strength and porosity requirement. Also, it will be appreciated that the processing of fibers into their preferred aspect ratio distribution may be performed at various points in the process. For example, fibers may be chopped by a third-party processor and delivered at a predetermined aspect ratio distribution. In another example, the fibers may be provided in a bulk form, and processed into an appropriate aspect ratio as a preliminary step in the extrusion process. It will be appreciated that the mixing, shear mixing or dispersive mixing, and extrusion aspects of process 1650 may also contribute to cutting and chopping of the fibers. Accordingly, the aspect ratio of the fibers introduced originally into the mixture will be different than the aspect ratio in the final cured substrate. Accordingly, the chopping and cutting effect of the mixing, shear mixing, and extrusion should be taken into consideration when selecting the proper aspect ratio distribution 1654 introduced into the process.

With the fibers processed to the appropriate aspect ratio distribution, the fibers, binders, pore formers, and fluids are mixed to a homogeneous mass as shown in block 1662. This mixing process may include a drying mix aspect, a wet mix aspect, and a shear mixing aspect. An S-blade mixer can be used during at least part of the process by way of example. It has been found that shear or dispersive mixing is desirable to produce a highly homogeneous distribution of fibers within the mass. This distribution is particularly important due to the relatively low concentration of ceramic material in the mixture. As the homogeneous mixture is being mixed, the rheology of the mixture may be adjusted as shown in block 1664. As the mixture is mixed, its rheology continues to change. The rheology may be subjectively tested, or may be measured to comply with the desirable area as illustrated in Table 5 of FIG. 6. Mixture falling within this desired area has a high likelihood of properly extruding. The wetted mixture (dough) is then extruded into a green substrate as shown in block 1668.

In the case of screw extruders, and particularly the illustrative twin screw extruder described above, decision block 1661 directs the system and method 1650 to blocks 1680 and 1682, which essentially simplify the procedure 1300 of FIG. 13. That is, after selecting the dry mixture components in accordance with blocks 1652, 1653, 1654, 1655, 1656 and 1658, the components are mixed into a homogeneous mass of dry components (block 1680). Note that in alternate embodiments the mixing of dry components may also happen inside the extruder itself, and not in a separate mixer. In such cases, the shear history of the mixture should be carefully managed and controlled. The substrate is then extruded (block 1682) after applying the dry components to the extruder by then adding fluid and associated additives to the extruder after selecting these in accordance with Table 4 of FIG. 6 (or according to another metric). The rheology of the extruding mixture can be adjusted in accordance with Table 5 of FIG. 6 (or according to another metric).

In either extrusion step (blocks 1668 or 1682), the resulting extruded green substrate has sufficient green strength to hold its shape and fiber arrangement during the curing process. The green substrate is then cured as shown the block 1690. The curing process includes removal of any remaining water, controlled burn off of most additives, and the forming of fiber to fiber bonds. During the burn-off process, the fibers maintain their tangled and intersecting relationship, and as the curing process proceeds, bonds are formed at the intersecting points or nodes. It will be appreciated that the bonds may result from a liquid state or a solid-state bonding process. Also, it will be understood that some of the bonds may be due to reactions with additives provided in the binder, such as in the formation of silicon carbide from carbon fiber and silicon powder, or the formation of cordierite from a reaction of magnesia aluminosilicate precursors. Reactions can also occur with regard to pore formers, coatings on the fibers, or in the fibers themselves. After bonds have been formed, the substrate is slowly cooled to room temperature.

Referring now to FIG. 8, a system and method 1775 for curing a porous fibrous substrate is illustrated. The system and method 1775 has a green substrate having a fibrous ceramic content. The curing process first slowly removes remaining water from the substrate as shown in block 1777. Typically, the removal of water may be done at a relatively low temperature in an oven. After the remaining water has been removed, the organic additives may be burned off as shown in block 1779. These additives are burned off in a controlled manner to facilitate proper arrangement of the fibers, and to ensure that escaping gases and residues do not interfere with the fiber structure. As the additives burn off, the fibers maintain their overlapping arrangement, and may further contact at intersecting points or nodes as shown in block 1781. The fibers have been positioned into these overlapping arrangements using the binder, and may have particular patterns formed through the use of pore formers. In some cases, inorganic additives may have been used, which may combine with the fibers, be consumed during the bond forming process, or remain as a part of the final substrate structure. The curing process proceeds to form fiber to fiber bonds as shown in block 1785. The specific timing and temperature required to create the bonds depends on the type of fibers used, type of bonding aides or agents used, and the type of desired bond. In one example, the bond may be a liquid state sintered bond generated between fibers as shown in block 1786. Such bonds are assisted by glass-formers, glasses, ceramic pre-cursors or inorganic fluxes present in the system. In another example, a liquid state sintered bond may be created using sintering aides or agents as shown in block 1788. The sintering aides may be provided as a coating on the fibers, as additives, from binders, from pore formers, or from the chemistry of the fibers themselves. Also, the fiber to fiber bond may be formed by a solid-state sintering between fibers as shown in block 1791. In this case, the intersecting fibers exhibit grain growth and mass transfer, leading to the formation of chemical bonds at the nodes and an overall rigid structure. In the case of liquid state sintering, a mass of bonding material accumulates at intersecting nodes of the fibers, and forms the rigid structure. It will be appreciated that the curing process may be done in one or more ovens, and may be automated in an industrial tunnel or kiln-type furnace.

The fiber extrusion system offers great flexibility in implementation. For example, a wide range of fibers and additives may be selected to form the mixture. Several mixing and extrusion options exist, as well as options related to curing method, time and temperature. With the disclosed teachings, one skilled in the extrusion arts will understand that many variations may be used. Honeycomb substrates are a common design to be produced using the technique described in the present invention, but other shapes, sizes, contours, designs can be extruded for various applications.

For certain applications, such as use in filtration devices (DPF, oil/air filters, hot gas filters, air-filters, water filters etc) or catalytic devices (such as 3-way catalytic converters, SCR catalysts, deozonizers, deodorizers, biological reactors, chemical reactors, oxidation catalysts etc) the channels in an extruded substrate may need to be plugged. Material of composition similar to the extruded substrate is used to plug the substrate. The plugging can be done in the green state or on a sintered substrate. Most plugging compositions require heat treatment for curing and bonding to the extruded substrate.

While particular preferred and alternative embodiments of the present intention have been disclosed, it will be apparent to one of ordinary skill in the art that many various modifications and extensions of the above described technology may be implemented using the teaching of this invention described herein, and that the description herein should be taken by way of example. For example, they type and arrangement of extrusion device described herein can differ from those examples and embodiments provided herein. Moreover it is contemplated that the twin screw concepts shown and described herein may be modified to operate with other types of screw extruders. Likewise, while a particular type of mixer is shown and described to carry out certain mixing tasks, other types of mixers are expressly contemplated to carry out such tasks. All such modifications and extensions are intended to be included within the true spirit and scope of the invention as discussed in the appended claims.

What is claimed is:

1. A method for extruding a porous honeycomb ceramic substrate comprising the steps of:
mixing a plurality of substantially dry materials comprising at least 20% fiber by volume adapted to form an extruded fibrous porous substrate into a homogeneous mixture;
feeding the homogeneous mixture at a predetermined feed rate to a screw extruder having a plurality of sections for performing each of transport and shear-mixing;
transporting the homogeneous mixture through the screw extruder in a downstream direction and adding fluid to the homogeneous mixture at a downstream location to define a wetted mixture;
applying shear-mixing the wetted mixture; and
directing the transported and shear-mixed mixture through a honeycomb die to define a continuous extruded honeycomb shape.

2. The method as set forth in claim 1 wherein the step of adding fluid includes providing a strengthening agent in the fluid.

3. The method as set forth in claim 1 wherein the step of mixing includes feeding predetermined quantities of each of a fiber, a pore former, a binder and a strengthening agent into a mixer.

4. The method as set forth in claim 3 wherein the step of mixing includes feeding mullite fiber into the mixer.

5. The method as set forth in claim 1 wherein the step of mixing and feeding each comprise continuously conveying predetermined quantities of the substantially dry materials to the mixer from the mixer and the extruder so as to continuously feed the extruder.

6. The method as set forth in claim 1 further comprising applying a vacuum to the shear-mixed mixture adjacent to the die so as to remove air from the shear-mixed mixture.

7. The method as set forth in claim 1 wherein the step of mixing comprises mixing the plurality of substantially dry materials for a predetermined time in a horizontal plow mixer.

8. The method as set forth in claim 1 wherein the screw extruder comprises a twin screw extruder.

9. A system for extruding a porous ceramic substrate comprising the steps of:
a mixer that mixes a plurality of substantially dry materials comprising at least 20% fiber by volume adapted to form an extruded fibrous porous substrate into a homogeneous mixture;
a twin screw extruder having a feed section that receives the homogeneous mixture and plurality of screw sections downstream of the feed section that perform each of transport and shear-mixing;
a wetting section downstream of the feed section that applies fluid to the homogeneous mixture to generate a wetted mixture;
kneading blocks that apply the shear mixing to the wetted mixture to generate a kneaded, wetted mixture;
a vacuum section downstream of the wetting section that removes air from the kneaded, wetted mixture; and
a honeycomb die into which the kneaded, wetted mixture is detected so as to define a continuous extruded honeycomb shape exiting therefrom.

10. The method as set forth in claim 9 wherein the mixer comprises a horizontal plow mixer.
